(19) United States
(12) Patent Application Publication
(10) Pub. No.: US 2010/0226131 A1
(43) Pub. Date: Sep. 9, 2010

(54) LIGHTING EQUIPMENT

(75) Inventors: Kazunari HIGUCHI, Yokohama-Shi (JP); Takayoshi Moriyama, Miura-Shi (JP); Sumio Hashimoto, Yokosuka-Shi (JP); Satoshi Watanabe, Mishima-Shi (JP); Hiroyuki Kuramochi, Joso-Shi (JP)

Correspondence Address: DLA PIPER LLP US, P. O. BOX 2758, RESTON, VA, 20195, US

(73) Assignees: TOSHIBA LIGHTING & TECHNOLOGY CORPORATION, Yokosuka-Shi (JP); KABUSHIKI KAISHA TOSHIBA, Minato-Ku (JP)

(21) Appl. No.: 12/717,154

(22) Filed: Mar. 4, 2010

(30) Foreign Application Priority Data
Mar. 5, 2009 (JP) 2009-052118

(51) Int. Cl. F21V 7/00

(52) U.S. Cl. 362/297

(57) ABSTRACT

LEDs, a reflector, and a baffle are disposed on the underside of the equipment main body. An emission opening for emitting light of the LEDs and a reflection surface for emitting light of the LEDs from the emission opening by reflecting the same are provided in the reflector. The baffle is disposed outside the direct light emission area where direct light from the LEDs is emitted from the emission opening of the reflector. The direct light from the LEDs can be picked up without being blocked by the baffle, and the light pick-up efficiency can be improved.

### INCORPORATION BY REFERENCE

The present invention claims priority under 35 U.S.C. §119 to Japanese Patent Application No. 2009-052118 filed on Mar. 5, 2009. The contents of these applications are incorporated herein by reference in their entirety.

### FIELD OF THE INVENTION

The present invention relates to lighting equipment using a semiconductor light-emitting element as a light source.

### BACKGROUND OF THE INVENTION

Conventionally, as described in Japanese Laid-Open Patent Publication No. 2008-204692, there is lighting equipment such as a downlight using an LED as a semiconductor light-emitting element. The lighting equipment has a substrate disposed at the equipment main body, which is mounted with a plurality of LEDs, has a reflector disposed at the underside of the substrate, which controls the distribution of light from the LEDs, has a transparent cover disposed at the underside of the reflector, and further has a decorative frame disposed at the lower part of the equipment main body, which supports the transparent cover and is attached to the ceiling surface in contact therewith.

The reflector has an emission opening for emitting light from an LED on the underside thereof, and a reflection surface for widening light from the LED toward the emission opening so as to emit the light from the emission opening by reflecting the same. A passage hole to allow light from the LED to pass there through is formed at the top part of the reflection surface.

Further, a baffle may be disposed between the reflector and the decorative frame as the second reflector in order to prevent glare. The baffle is formed to be ring-shaped having a reflection surface widened toward the underside opening, and an upper side opening opposed to the reflector is formed at the top part of the reflection surface. Where the baffle is used, a transparent cover is disposed at the upper side opening of the baffle, and the transparent cover is held by the edge part of the upper side opening of the baffle.

However, where the baffle is used to prevent glare, if the edge part of the upper side opening of the baffle is located near the emission opening of the reflector, a part of the light emitted from the emission opening of the reflector is blocked by the edge part of the upper side opening of the baffle, causing a problem in which the light pick-up efficiency of picking up outer light of the LED is lowered. In particular, since the direct light from the LED is blocked by the baffle, this easily adversely lowers the light pick-up efficiency.

The present invention was developed in view of these points, and it is therefore an object of the invention to provide lighting equipment that can improve the light pick-up efficiency.

### SUMMARY OF THE INVENTION

Lighting equipment according to the present invention includes a semiconductor light-emitting element, a first reflector having an emission opening for emitting light of the semiconductor light-emitting element and a reflection surface for emitting the light of the semiconductor light-emitting element from the emission opening by reflecting the same, and a second reflector disposed outside the direct light emission area where direct light from the semiconductor light-emitting element is emitted from the emission opening of the first reflector.

According to the lighting equipment, since the second reflector is disposed outside the direct light emission area where direct light from the semiconductor light-emitting element is emitted from the emission opening of the first reflector, it is possible to pick up the direct light from the semiconductor light-emitting element, which is blocked by the second reflector, and the light pick-up efficiency can be improved.

Also, for example, an LED chip element and an organic EL element can be used as the semiconductor light-emitting element. It does not matter whether the semiconductor light-emitting element is singular or plural in number.

Light emitted from the emission opening of the first reflector includes direct light from the semiconductor light-emitting element and reflection light that light from the semiconductor light-emitting element is reflected by the reflection surface. The first reflector may be provided with reflection parts divided per semiconductor light-emitting element if a plurality of semiconductor light-emitting elements are provided.

It suffices that the second reflector is disposed outside the direct light emission area where direct light from the semiconductor light-emitting element is emitted from the emission opening of the first reflector. However, if the second reflector is too far toward the outer side, the uniformity ratio of illuminance in brightness will be lowered when looking at the second reflector. Therefore, it is preferable that the second reflector is close to the direct light emission area so as to be brought into contact with the boundary thereof.

The lighting equipment may be, for example, a downlight, and glare is controlled by using the second reflector.

In addition, the lighting equipment according to the present invention is such that, in the first reflector, a reflection surface is formed so as to be widened toward the emission opening, a passage hole through which light of the semiconductor light-emitting element passes is formed at the top part of the reflection surface that becomes an opposite side to the emission opening, and a rise surface tilted so as to be widened toward the emission opening is formed at the inner edge of the passage hole.

According to the present invention, since the rise surface is formed at the inner edge of the passage hole of the first reflector, a width dimension necessary to mold the first reflector can be secured, and light reflected by the rise surface can be emitted from the emission opening without being re-reflected by the reflection surface of the first reflector by causing the rise surface to be tilted so as to be widened toward the emission opening, wherein the light pick-up efficiency can be improved.

Further, if the rise surface of the first reflector is edge-shaped to continue the reflection surface formed so that the inner edge of the passage hole is widened toward the emission opening, it becomes difficult to mold the rise surface by, for example, injection molding. However, a width dimension necessary to mold is secured so as not to become edge-shaped by providing the rise surface. By causing the rise surface to be tilted so as to be widened toward the emission opening, the loss of light, which is caused by re-reflection of the light, which is reflected by the rise surface, by the reflection surface of the first reflector is reduced, wherein improvement in the light pick-up efficiency is enabled. It is preferable that the angle for tilting the rise surface is in a range from 15° to 40°, that is, optically 15° or more with the light pick-up efficiency taken into consideration and 40° or less in terms of moldability with respect to the optical axis direction from the semiconductor light-emitting element toward the emission opening of the first reflector. A preferable range is 15° to 25° with the moldability further taken into consideration, and, for example, 20° or so is most suitable in terms of both optical features and moldability.

### BRIEF DESCRIPTION OF THE DRAWINGS

FIG. 1 is a partially sectional view of lighting equipment, showing one embodiment of the present invention;

FIG. 2 is a sectional view of a reflector of the same lighting equipment;

FIG. 3 is a side elevational view of the same lighting equipment;

FIG. 4 is a bottom view of the same lighting equipment;

FIG. 5 is a plan view of the equipment main body of the same lighting equipment; and

FIG. 6 is a partially perspective view of the same lighting equipment.

### DETAILED DESCRIPTION OF THE PREFERRED EMBODIMENT

Hereinafter, a description is given of one embodiment of the present invention with reference to the drawings.

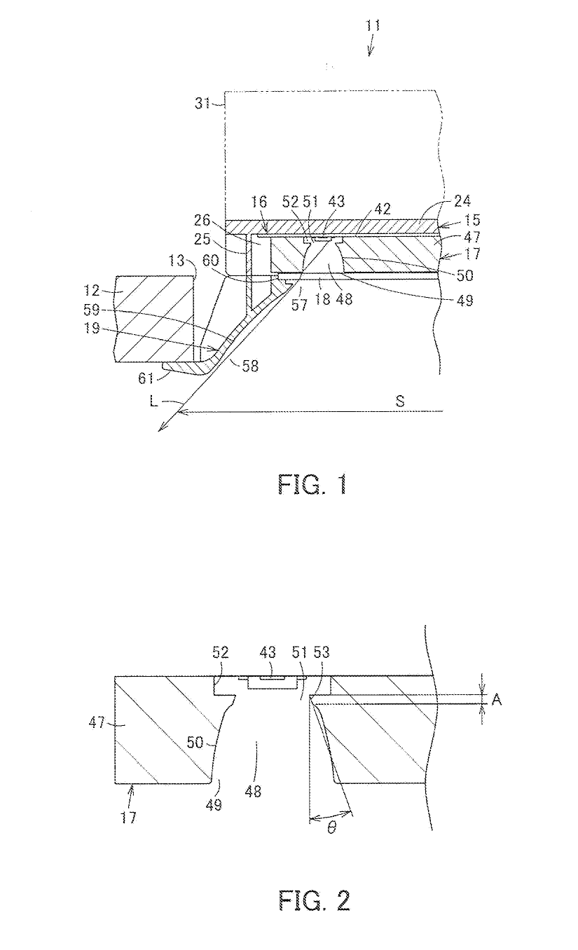

As shown in FIG. 1, lighting equipment 11 is, for example, a downlight which is embedded and installed in a circular embedding hole 13 provided in a ceiling member 12 such as a ceiling plate.

As shown in FIGS. 1 to 6, the lighting equipment 11 is provided with an equipment main body 15, a light source module 16 attached to the underside of the equipment main body 15, a reflector 17 acting as the first reflector, which is attached to the underside of the light source module 16, a transparent cover 18 disposed on the underside of the reflector 17, a baffle 19 acting as the second reflector, which is attached to the underside of the equipment main body 15, a pair of attaching springs 20 which acts to attach the equipment main body 15 to the ceiling member 12 and is attached to the outer side surface of the equipment main body 15, and a power source unit and a terminal board, etc., which are not illustrated.

The equipment main body 15 is formed of a metallic material, such as, for example, aluminum, which is concurrently used as a heat-radiating member for radiating heat generated by the light source module 16, and has a circular substrate portion 24. A cylindrical tubular portion 25 is formed in the vicinity of the lower-side circumferential part of the substrate portion 24, and a light source accommodating portion 26 is formed inside the tubular portion 25, which accommodates the light source module 16, the reflector 17, etc.

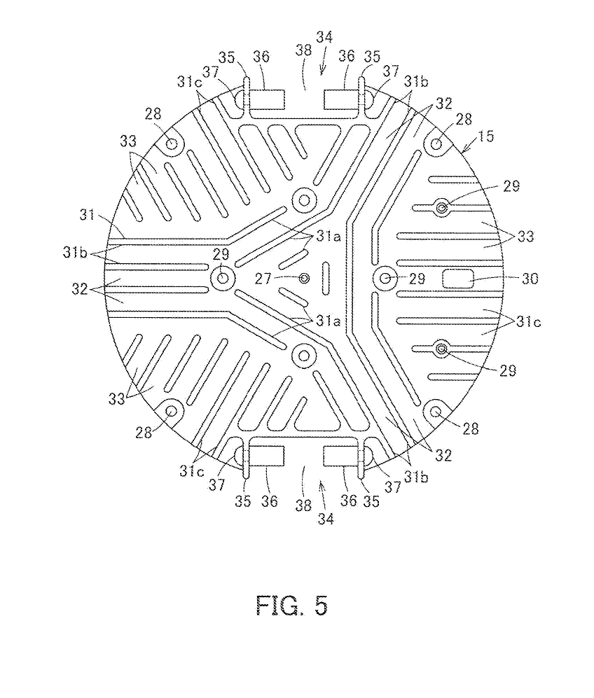

As shown in FIG. 5, an attaching hole 27 for screwing the reflector 17 is formed at the center of the substrate portion 24 with the light source module 16 placed between the reflector 17 and the underside of the substrate portion 24, and a plurality of attaching holes 28 for screwing the baffle 19 are formed at the circumferential part of the substrate portion 24. Further, a plurality of attaching holes 29 for attaching a power source unit and a wiring hole 30 for connecting the power source unit to the light source module 16 by a cable are formed in the substrate portion 24.

A plurality of heat-radiating fins 31 are formed on the upper side of the substrate portion 24. The heat-radiating fins 31 are disposed so that, when being observed in plan view as shown in FIG. 5, a plurality of heat-radiating fin parts 31a at the center region are disposed with spacing therebetween along respective sides of a triangle at the center region of the substrate portion 24, and a plurality of radial heat-radiating fin parts 31b are disposed with spacing therebetween along the radial direction from respective top points of the triangle at the heat-radiating fin parts 31a at the center region, at the circumferential region of the substrate portion 24. And, gaps (spacing) between the heat-radiating fin parts 31a at the center region communicate with gaps (spacing) between a plurality (three) of radial heat-radiating fin parts 31b, respectively, and a plurality of ventilation flues 32 for causing the center region of the heat-radiating fins 31 to communicate with the outer side surface thereof are formed. Further, a plurality of heat-radiating fin parts 31c at the circumferential part are disposed at three points between the heat-radiating fin parts 31a at the center region and three radial heat-radiating fin parts 31b at the circumferential part of the substrate portion 24 with spacing therebetween so as to be oriented from the center region of the substrate portion 24 to the outer side surface thereof. A ventilation flue 33 that communicates the center region of the heat-radiating fins 31 with the outer side surface thereof is formed in the gap (spacing) between the heat-radiating fin parts 31c at the circumferential part.

A spring attaching portion 34 for attaching an attaching spring 20 is formed at two points that are symmetrical to the outer side surface of the equipment main body 15. The spring attaching portion 34 is provided with a pair of attaching pieces 35 with a predetermined space therebetween. An attaching shaft 36 is disposed inside the respective attaching pieces 35, and respective attaching shafts 36 are fixed by screwing a screw 37 in the attaching shaft 36 from the outer side of the respective attaching pieces 35. A gap 38 for attaching the attaching spring 20 is provided between the tip ends of a pair of attaching shafts 36. Also, although a pair of attaching shafts 36 are attached to the equipment main body 15 by screws 37, the present invention is not limited thereto, wherein a pair of attaching shafts 36 may be formed to be integral with the equipment main body 15.

In addition, as shown in FIGS. 1 and 4, the light source module 16 has a substrate 42 formed to be disk-shaped using a metallic material such as, for example, aluminum and a wiring pattern is formed on the surface of the substrate 42 via an insulation layer. LEDs 43 acting as a plurality of semiconductor light-emitting elements are mounted on the wiring pattern so as to be electrically and mechanically connected thereto.

The substrate 42 is fixed with the rear side, on which no LED 43 is mounted, closely face-contacted to the underside of the substrate portion 24 of the equipment main body 15, in a state where the substrate 42 is placed between the substrate portion 24 and the reflector 17 fixed on the substrate portion 24 with a screw.

The LEDs 43 are disposed with a fixed interval around the center part of the substrate 42, and a plurality of rows thereof are concentrically arranged. Also, the LED 43 is composed of, for example, an LED chip for emitting blue light, a reflector for reflecting light forward, and a sealing member containing a fluorescent body for radiating mainly yellow light, which is excited by blue light that the LED chip emits. Therefore, the LED 43 in which an LED chip is used as a spot-shaped primary light source project white light from the surface of the sealing member that becomes a plane-shaped secondary light source.

Further, the reflector 17 is attached to the underside of the substrate portion 24 by a screw screwed through the attaching hole 27 from the upper surface side of the substrate portion 24 in a state where the light source module 16 is placed between the reflector 17 and the underside of the substrate portion 24 of the equipment main body 15.

As shown in FIGS. 1, 2 and 4, the reflector 17 has a reflection plate 47 that is formed to be disk-shaped using, for example, white synthetic resin, and a plurality of reflection parts 48 for controlling the distribution of light emitted by the respective LEDs 43 are formed on the reflection plate 47 so as to correspond to the positions of the respective LEDs 43 of the light source module 16.

The respective reflection parts 48 are formed hole-shaped having a through opening at the upper and lower surfaces of the reflection plate 47, and an emission opening 49 for emitting light of the LEDs 43 is formed on the underside. A reflection surface 50 widened toward the emission opening 49 is formed so as to reflect light of the LEDs 43 and emit the light from the emission opening 49. A circular passage hole 51 through which light of the LEDs 43 passes is formed at the top part of the reflection surface 50 that becomes an opposite side to the emission opening 49, and a recessed portion 52 for accommodating the LEDs 43 and its peripheral parts is formed on the upper side of the passage hole 51.

As shown in FIG. 4, the emission opening 49 is formed to be fan-shaped or to be shaped in approximation of a fan around the center part of the reflector 17, and is formed to be shaped in approximation of a singular circular opening as a whole.

As shown in FIG. 2, a rise surface 53 of a width dimension (thickness dimension) A necessary to mold the reflector 17 by, for example, injection molding, is formed at the end part at the top part side of the reflection surface 50, that is, the inner edge of the passage hole 51, and the rise surface 53 is tilted so as to be widened toward the emission opening 49 at a smaller tilt angle than the tilt of the reflection surface 50. With respect to the rise surface 53, although it is difficult to mold the rise surface 53 by, for example, injection molding if the inner edge of the passage hole 51 is edge-shaped to continue the reflection surface 50 formed so as to be widened toward the emission opening 49, a width dimension necessary to mold can be secured so as not to become edge-shaped by providing the rise surface 53. In addition, if the rise surface 53 is a plane parallel to the optical axis direction from the LEDs 43 toward the emission opening 49 of the reflector 17, a majority of light incident from the LEDs 43 into the rise surface 53 is reflected to the reflection surface 50, wherein since light is emitted while being repeatedly re-reflected by the reflection surface 50, the loss of light is brought about due to re-reflection from the reflection surface 50 and the light pick-up efficiency is lowered. However, by causing the rise surface 53 to be tilted so as to be widened toward the emission opening 49, it is possible to emit light reflected by the rise surface 53 from the emission opening 49 without entering the reflection surface 50 of the reflector 17, wherein improvement in the light pick-up efficiency is enabled. It is preferable that the angle θ for tilting the rise surface 53 is in a range from 15° to 40°, that is, optically 15° or more with the light pick-up efficiency taken into consideration and 40° or less in terms of moldability with respect to the optical axis direction from the LED 43 toward the emission opening 49 of the reflector 17. A preferable range is 15° to 25° with the moldability taken into further consideration, and, for example, 20° or so is most suitable in terms of both optical features and moldability.

Further, as shown in FIG. 1, the transparent cover 18 is formed to be disk-shaped using, for example, a transparent glass plate and transparent acrylic resin plate, etc. The circumferential edge part thereof is fitted into the baffle 19, and is placed and attached between the reflector 17 and the baffle 19 screwed to the equipment main body 15. And, the transparent cover 18 is disposed to stop up the respective emission openings 49 of the reflector 17.

Also, as shown in FIGS. 1, 3, 4 and 6, the baffle 19 is made of, for example, white synthetic resin, and is formed into a circular frame body, the upper side and underside of which are open. The upper side opening 57 is smaller than the underside opening (opening for light projection) 58, and a reflection surface 59 widened toward the underside opening 58 is formed on the inner surface of the upper side opening 57.

A fitting part 60 for fitting the circumferential edge part of the transparent cover 18 is formed at the upper end circumferential edge part to form the upper side opening 57 of the baffle 19.

A decorative frame 61, which is larger in diameter than the embedding hole 13 of the ceiling member 12 and is brought into contact with the underside of the ceiling member 12 in a state where the lighting equipment 11 is embedded and installed in the ceiling member 12, is formed at the lower end circumferential edge part of the baffle 19 to be integral therewith. Also, the decorative frame 61 maybe formed to be separate from the baffle 19.

The baffle 19 is disposed at the underside of the equipment main body 15 and is linked to the lower end of the equipment main body 15 by a screw screwed through the attaching hole 29 from the upper side of the substrate portion 24 of the equipment main body 15. At this time, the baffle 19 fixes the transparent cover 18 fitted in the fitting part 60 in a state where the transparent cover 18 is placed between the baffle 19 and the reflector 17.

At least the upper end part of the baffle 19 attached to the equipment main body 15 is disposed outside the direct light emission area S where direct light L from the LEDs 43 is emitted from the emission opening 49 of the reflector 17. At this time, where the transparent cover 18 is arranged at the emission opening 49 side of the reflector 17, the baffle 19 is located outside the direct light emission area S where refraction of light by the transparent cover 18 is taken into consideration. Also, if the baffle 19 is too far toward the outer side from the center of the equipment, the circumferential part that does not emit any light of the reflector 17 is exposed, and is viewed as a dark part when the lighting equipment 11 is observed from below, wherein since the uniformity ratio of illuminance in brightness is lowered, it is preferable that the baffle 19 is close to the direct light emission area S so as to be brought into contact with the boundary thereof.

A stopper 62 that, when the baffle 19 is attached to the equipment main body 15, enters respective spring attaching portions 34 of the equipment main body 15 and is disposed in the gap 38 between the tip ends of a pair of attaching shafts 36 is formed so as to protrude at two points that are symmetrical to the outer side surface of the baffle 19. A regulating part 63 with which the attaching springs 20 are brought into contact is provided at the upper edge part of the baffle 19 at both sides of the stopper 62.

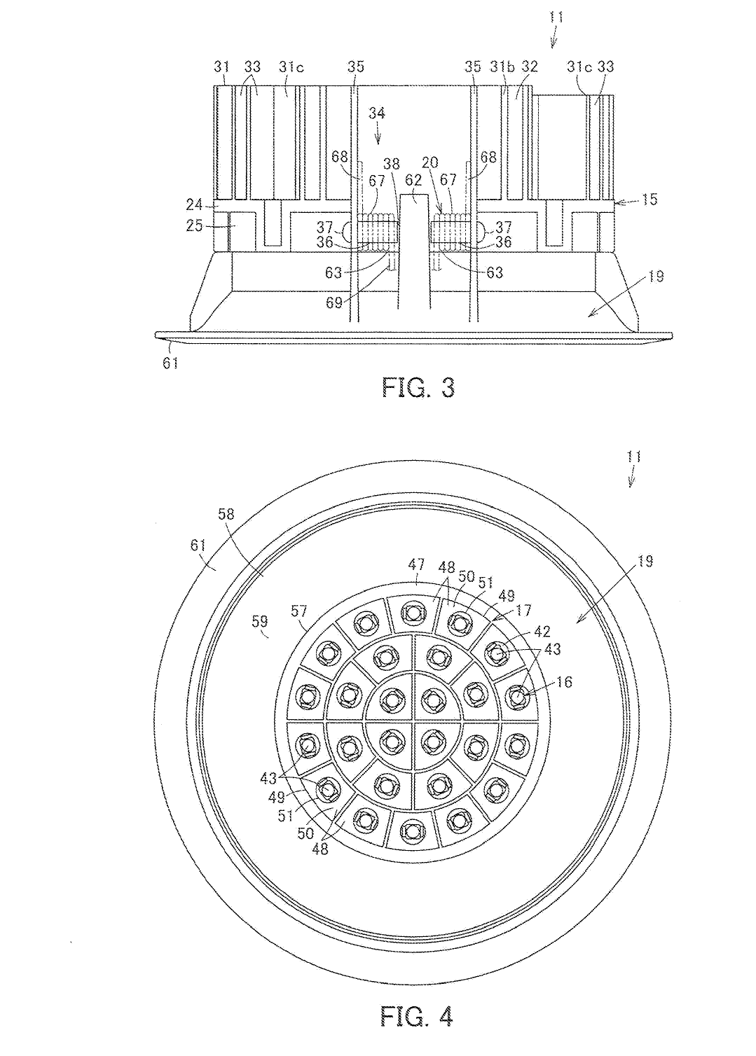

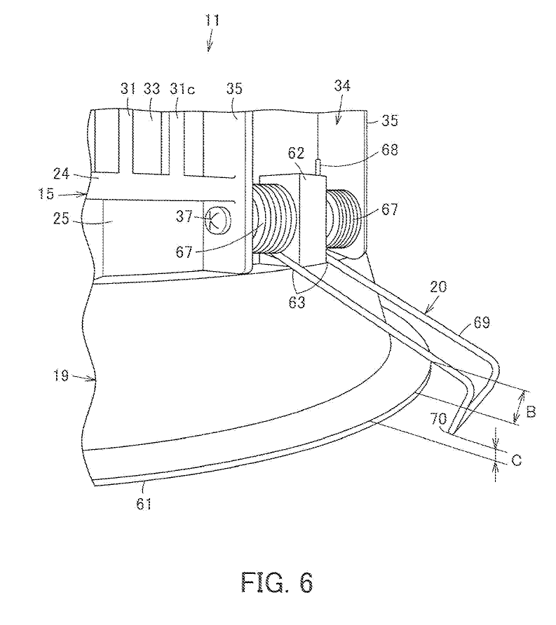

In addition, as shown in FIGS. 3 and 6, the attaching spring 20 is composed of a torsion spring (a double torsion spring having a pair of coils), and a pair of coil parts 67 wound coil-shaped are formed in the vicinity of both ends of a wire material having a spring property, and an end part 68 is caused to extend from the pair of coil parts 67, and a pressing part 69 being an intermediate part is linearly extended from the pair of coil parts 67, and a contacting part 70 folded downward is formed at the tip end part of the pressing part 69.

The attaching spring 20 is attached to the spring attaching portion 34 of the equipment main body 15 before attaching the baffle 19 to the equipment main body 15, and the respective coil parts 67 are mounted at the circumference of the respective attaching shafts 36 through the gap 38 between the tip ends of a pair of attaching shafts 36. Subsequently, the stopper 62 of the baffle 19 is disposed in the gap 38 between the tip ends of a pair of attaching shafts 36 by attaching the baffle 19 to the equipment main body 15, thereby preventing the coil part 67 from falling off from the attaching shaft 36. The regulating part 63 of the baffle 19 is brought into contact with the pressing part 69 of the attaching spring 20 and pushes it upward when the baffle 19 is attached to the equipment main body 15, thereby twisting and deforming the coil part 67. Since both end parts 68 are brought into contact with the inner wall side of the spring attaching portion 34 due to twisting deformation of the coil part 67, a repulsion force for pressing the pressing part 69 downward is generated. In a state before installation, the base end side of the pressing part 69 pressed downward is brought into contact with the regulating part 63 of the baffle 19, and downward movement is regulated. In the regulated state, the tip end side of the pressing part 69 protrudes outward of the decorative frame 61 of the baffle 19, wherein the minimum distance B between the tip end side of the pressing part 69 and the baffle 19 (the decorative frame 61) is secured at 15 mm or more. However, the interval C in the up and down direction between the contacting part 70 at the tip end of the pressing part 69 and the upper surface of the decorative frame 61 becomes 5 mm or less.

And, during installation of the lighting equipment 11, the pressing part 69 of a pair of attaching springs 20 is elastically deformed upward by hand after wiring of the power source is finished, and is aligned with the side of the equipment main body 15. And, the equipment main body 15 and the tip end side of the pressing part 69 of the attaching spring 20 are inserted into the embedding hole 13 of the ceiling member 12, and by releasing a hand from the attaching spring 20, the pressing part 69 is developed so as to be widened sideways by the elasticity of the attaching spring 20, and at the same time, the pressing part 69 and the tip end contacting part 70 are brought into contact with the upper surface side of the ceiling member 12, and the equipment main body 15 is relatively lifted up. By the decorative frame 61 being brought into contact with the underside of the ceiling member 12, the ceiling member 12 is placed and held between the decorative frame 61 and the contacting part 70 of the pressing part 69, wherein the lighting equipment 11 is embedded and installed in the ceiling member 12.

Also, the stopper 62 maybe composed to be separate from the decorative frame 61, and after the decorative frame 61 is attached to the equipment main body 15, the stopper 62 may be attached to the decorative frame 61.

Light emitted from the LEDs 43 by lighting of the LEDs 43 of the lighting equipment 11 is emitted from the emission opening 49 of the reflector 17, passes through the transparent cover 18, and is projected downward from the underside opening 58 of the baffle 19.

A part of the light emitted from the LEDs 43 is emitted from the emission opening 49 without being reflected by the reflection surface 50 of the reflector 17, passes through the transparent cover 18 and is projected downward. In addition, a part of the light is emitted from the emission opening 49 by being reflected by the reflection surface 50 of the reflector 17, passes through the transparent cover 18 and is projected downward. Further, a part of the light passed through the transparent cover 18 is projected downward without being reflected by the reflection surface 59 of the baffle 19. In addition, a part of the light is projected downward by being reflected by the reflection surface 59 of the baffle 19.

At this time, since the baffle 19 is disposed outside the direct light emission area S where the direct light L from the LEDs 43 is emitted from the emission opening 49 of the reflector 17, the direct light L from the LEDs 43 can be picked up without being blocked by the upper end part of the baffle 19, wherein the light pick-up efficiency can be improved.

Further, by forming the rise surface 53 on the inner edge of the passage hole 51 of the reflector 17, a width dimension necessary to mold the reflector 17 can be secured, and by causing the rise surface 53 to be tilted so as to be widened toward the emission opening 49, light reflected by the rise surface 53 can be emitted from the emission opening 49 without being re-reflected by the reflection surface 50 of the reflector 17, wherein the light pick-up efficiency can be improved.

Further, although there are some types of general lighting equipment in which heat-radiating fins are provided in the equipment main body in order to radiate heat that is generated when lighting LEDs, sufficient heat radiation performance cannot be obtained because ventilation, etc., have not been taken into sufficient consideration.

In the lighting equipment 11 according to the present embodiment, as for the heat-radiating fins 31, a plurality of heat-radiating fin parts 31a at the center region are disposed with spacing therebetween along respective sides of a triangle at the center region of the substrate portion 24 when being observed in plan view as shown in FIG. 5, and a plurality of radial heat-radiating fin parts 31b are disposed with spacing therebetween along the radial direction from the respective top points of the triangle at the heat-radiating fin parts 31a at the center region. Therefore, the gaps (spacing) between the heat-radiating fin parts 3 la at the center region communicate with the gaps (spacing) between the three radial heat-radiating fin parts 31b, respectively, and a plurality of ventilation flues 32 for causing the center region of the heat-radiating fins 31 to communicate with the outer side surface thereof are thereby formed.

Heat that is generated when lighting the LEDs 43 is thermally transmitted from the substrate 42 to the heat-radiating fins 31 through the substrate portion 24 of the equipment main body 15, and is radiated in air from the heat-radiating fins 31. However, as shown in FIG. 4, since a plurality of LEDs 43 are disposed with density at the center region of the equipment main body 15, the temperature of the heat-radiating fins 31 at the center region of the equipment main body 15 becomes higher than that at the circumferential region.

In line with upward currents of air warmed by the heat-radiating fins 31 at the center region where the temperature is higher, air not warmed at the lateral region of the heat-radiating fins 31 is flown into the heat-radiating fins 31 at the center region through a plurality of the ventilation flues 32, and simultaneously, such an air current is brought about, by which air is warmed by the heat-radiating fins 31 at the center region and is caused to move upward, wherein the heat radiation performance can be improved.

Further, a plurality of heat-radiating fin parts 31c at the circumferential part of the substrate portion 24 are disposed with spacing therebetween so as to be oriented from the center region of the substrate portion 24 to the outer side surface thereof at three points between the heat-radiating fins 31a at the center region and three radial heat-radiating fins 31b at the circumferential part of the substrate portion 24. Ventilation flues 33 for causing the center region of the heat-radiating fins 31 to communicate with the outer side surface thereof are formed in the gaps (spacing) between the heat-radiating fin parts 31c at the circumferential part. Therefore, currents of air not warmed at the lateral region of the heat-radiating fins 31, by which the air flows to the heat-radiating fins 31 at the center region, are brought about also in the ventilation flues 33, wherein the heat radiation performance can be improved.

Also, in general lighting equipment, there are many cases where, in order to attach the equipment main body to a ceiling member, plate springs acting as attaching springs are caused to protrude sideways of the equipment main body and the lighting equipment is attached by placing the ceiling member between the plate springs and the decorative frame. However, there may be cases where torsion springs are used as the attaching spring. In the case of the torsion spring, the coil part is attached to the equipment main body, and the equipment main body is attached to the ceiling member by placing the ceiling member between the contacting part extending from the coil part and the decorative frame. In a state before installation, the contacting part of the torsion spring has downward elasticity and is brought into contact with and fixed at the decorative frame. During installation, the contacting part of the torsion spring is elastically deformed upward against the elasticity and is aligned with the side of the equipment main body, and is inserted into the embedding hole of the ceiling member. However, when a hand is released from the contacting part of the torsion spring during installation, the contacting part thereof is returned downward by the elasticity, wherein there is a fear that fingers will be caught between the contacting part and the decorative frame.

On the contrary, in the lighting equipment 11 according to the present embodiment, in a state before installation, the base end side of the pressing part 69 pressed downward of the attaching spring 20 is brought into contact with the regulating part 63 of the baffle 19, and downward movement thereof is regulated. In the regulated state, the tip end side of the pressing part 69 protrudes outward of the decorative frame 61 of the baffle 19, wherein the minimum distance B between the tip end side of the pressing part 69 and the baffle 19 (the decorative frame 61) is secured 15 mm or more.

Therefore, during installation of the lighting equipment 11, even when a hand is released from the pressing part 69 and the pressing part 69 is returned downward by the elasticity of the attaching springs 20 until the equipment main body 15 and the tip end side of the pressing part 69 of the attaching springs 20 are inserted into the embedding hole 13 of the ceiling member 12 with the pressing part 69 of a pair of the attaching springs 20 elastically deformed upward by hand and aligned with the side of the equipment main body 15, the base end side of the pressing part 69 is brought into contact with the regulating part 63 of the baffle 19 and the minimum distance B between the tip end side of the pressing part 69 and the baffle 19 (the decorative frame 61) is secured at 15 mm or more, wherein it is possible to prevent fingers from being caught between the tip end side of the pressing part 69 and the baffle 19 (the decorative frame 61). Also, when the minimum distance B is less than 15 mm, there is a possibility that fingers will be caught between the tip end side of the pressing part 69 and the baffle 19 (the decorative frame 61).

In addition, since the contacting part 70 is bent downward from the tip end of the pressing part 69 and the interval C in the up and down direction between the tip end of the contacting part 70 and the upper surface of the decorative frame 61 is kept at 5 mm or less although the minimum distance B between the tip end side of the pressing part 69 and the baffle 19 (the decorative frame 61) is secured at 15 mm or more, the ceiling member 12 can be reliably placed between the contacting part 70 of the pressing part 69 and the decorative frame 61 in a state where the lighting equipment 11 is installed, and it is possible to attach the lighting equipment 11 to the ceiling member 12 without any play.

Further, although, in general lighting equipment, there are cases where a torsion spring is used as an attaching spring as described above, there are many cases where, in order to attach the torsion spring to the lighting equipment main body, a screw is inserted through the interior of the coil part of the torsion spring and the torsion spring is attached to the equipment main body. Still further, there may be cases where a double torsion spring having a pair of coil parts is used. In this case, by providing a pair of attaching shafts at the equipment main body side with a predetermined gap, it is possible to easily attach the respective coil parts to the respective attaching shafts through the gap. However, since there is a possibility for the coil part to come out through the gap, it is necessary to attach another drop-preventing member to the gap, wherein the number of components is increased, and the assemblability cannot be sufficiently improved.

On the contrary, in the lighting equipment 11 according to the present embodiment, by attaching the baffle 19 to the equipment main body 15 in which a pair of coil parts 67 of the attaching spring 20 are mounted on a pair of attaching shafts 36 since the stopper 62 is provided at the baffle 19, the stopper 62 of the baffle 19 is arranged in the gap 38 between the tip ends of a pair of attaching shafts 36, wherein it is possible to prevent the coil part 67 of the attaching spring 20 from falling off from the attaching shaft 36. Accordingly, it is not necessary to attach another drop-preventing member to the gap, wherein the number of components can be reduced, and the assemblability can be improved.

Also, an attaching portion (not illustrated) to attach a plate spring to the baffle 19 is formed, and the plate spring may be used as the attaching spring 20.

What is claimed is:

1. Lighting equipment comprising:
a semiconductor light-emitting element;
a first reflector having an emission opening for emitting light of the semiconductor light-emitting element and a reflection surface for emitting the light of the semiconductor light-emitting element from the emission opening by reflecting the same; and
a second reflector disposed outside the direct light emission area where direct light from the semiconductor light-emitting element is emitted from the emission opening of the first reflector.

2. The lighting equipment according to claim 1, wherein, in the first reflector,
a reflection surface is formed so as to be widened toward the emission opening;
a passage hole through which light of the semiconductor light-emitting element passes is formed at the top part of the reflection surface that becomes an opposite side to the emission opening; and
a rise surface tilted so as to be widened toward the emission opening is formed at the inner edge of the passage hole.
